(19) United States
(12) Patent Application Publication
(10) Pub. No.: US 2008/0069922 A1
(43) Pub. Date: Mar. 20, 2008

(54) Oil Seed Processing

(75) Inventor: Gavyn Anderson, Hawthorn (AU)

Correspondence Address: CONNOLLY BOVE LODGE & HUTZ LLP, 1875 EYE STREET, N.W., SUITE 1100, WASHINGTON, DC, 20036, US

(73) Assignee: Natura Holdings Pty Ltd., Hawthorn (AU)

(21) Appl. No.: 11/863,922

(22) Filed: Sep. 28, 2007

Related U.S. Application Data
(63) Continuation-in-part of application No. 10/344,583, filed on Feb. 13, 2003, now abandoned.

(30) Foreign Application Priority Data
Aug. 11, 2000 (AU) PQ 9310
Mar. 2, 2001 (AU) PR 3440

(51) Int. Cl. A21D 2/28; A23D 9/007; A23D 9/04

(52) U.S. Cl. 426/44; 426/430; 426/601; 426/629

(57) ABSTRACT

Sesame seeds are dehulled, coarsely ground while still wet in the presence of a 70/30 water alcohol mixture, to extract the oil. The oil is removed by decanting and the coarsely ground seeds are separated from the remaining liquids and dried to form a high protein flour. A further fine grinding produces a good quality sesame seed flour. The flour may be further treated to extract water soluble proteins and these may be treated with enzymes to produce peptides.

This application is a Continuation-In-Part of co-pending U.S. application Ser. No. 10/344,583 filed Feb. 13, 2003, which is the National Stage of International Application No. PCT/AU01/00983 filed Aug. 10, 2001, and claims priority to Application No. PQ 9310 filed in Australia on Aug. 11, 2000 and Application No. PR 3440 filed in Australia on Mar. 2, 2001 under 35 U.S.C. §119; the entire contents of all are hereby incorporated by reference

This invention relates to the extraction of oil and proteins and the production of flour from oil seeds in particular sesame seeds.

### BACKGROUND TO THE INVENTION

Most oil seeds are processed to extract oil and the ground seed byproduct is usually sold as meal for animal feed.

The seeds may be cold crushed to extract the oil but the residual oil left in the crushed seeds is still above 10% usually about 13%.

The expeller process heats the seeds and then crushes them in a screw press to extract the oil. The expeller process is more efficient than the cold press technique but still leaves about 9% oil in the meal residue.

Solvent extraction has been used to extract oil from this residue to reduce the oil content of the meal to 1 %. The solvent that is most effective is hexane.

U.S. Pat. No. 3,816,389 discloses a method of extracting oil from seeds in which the seeds are first ground in the presence of an alcohol to remove water from the ground seeds and then in a second step remaining solids are treated with an oil dissolving solvent such as hexane. This has the disadvantage of requiring extensive clean up to reduce the residual hexane in the meal by product if it is intended for human use. The meal byproduct is only fit for animal feeds and can not be used for human foods unless hexane is removed by washing, usually in a water alcohol solution. The oil is recovered from the solvent in a third step.

U.S. Pat. No. 3,419,056 addresses the problem of dehulling sesame seeds and does this by soaking the seeds in water, rubbing the grain to separate the hulls from the seeds, then placing the hulls and seeds in a brine solution so that the seeds float and the hulls sink. The seeds are then separated and dried.

U.S. Pat. No. 5,928,696 discloses a method for recovering oil in which dry seeds are finely ground in the dry state and then treated with a water and alcohol mixture to separate out an oil layer. This process is not as efficient or cost effective as the hexane process but it leaves no unwanted solvent in the dry residue and the residue is fit for human consumption. However the method is time and energy consuming for some seeds such as sesame seeds, because they have to be wet with water, dehulled in the wet state, dried, ground mixed with alcohol and then the oil is extracted using specially designed centrifugal decanters. Also with some seeds such as sesame the fine grinding makes it difficult to achieve easy separation of the oil phase from the water phase. There also remains the problem that to make the process as cost effective as possible the byproducts have to be valuable commodities as well.

Japanese patent 9187226 discloses an extraction method using hexane to remove oil and then treating the defatted material with an enzyme to give a protein peptide mixture.

Japanese patent 10014526 discloses the treatment of defatted sesame seed with an acid resistant protease to form peptides and amino acids having a large amount of bonds to trace metals.

It is an object of this invention to provide a safe an efficient method of producing a low fat flour and protein extracts from oil seeds.

### BRIEF DESCRIPTION OF THE INVENTION

To this end the present invention provides a method of producing a flour and oil from oil seeds which includes the steps of
a) dehulling the seeds in the presence of water alone and removing the hulls
b) coarse grinding the wet dehulled seeds from step a) in the presence of a water and alcohol mixture which contains 10 to 40% alcohol by weight of water to release oil from the seeds and form an oil phase separated from the water phase
c) decanting the oil from the ground seeds
d) optionally repeating steps b) and c)
e) drying the ground seeds
f) finely grinding the ground seeds to form a flour at any time after step d)
g) wherein the temperature during steps a) to f) is maintained below 70° C.

This invention is predicated on the discovery that extraction of oil from finely ground wet seeds is inhibited by the fine particle sizes of the fibres. The necessity of using dry seeds for the initial grinding adds extra cost where dehulling has to be carried out with wet seeds. In contrast this invention uses the wet dehulled seeds and coarse grinds the seeds in the presence of a water/alcohol mixture to immediately form a separate oil phase.

In order to dehull the seeds, the cleaned seeds are saturated with 50-100% by weight of water.

After dehulling, the wet seeds are coarsely ground to a particle size below 700 microns preferably 300-500 microns in the presence of a water alcohol mixture. The alcohol added to the water in the oil extraction process is preferably ethanol but any lower aliphatic alcohol such as methanol, propanol, or butanol may be used. The alcohol content is from 10 to 40% by weight of total added water including the added water absorbed into the dehulled seeds. A preferred water/alcohol mix is 70/30. The alcohol may be added to the dehulled seeds prior to the addition of more water. The solids content of the alcohol/water slurry is 30-60% by weight.

After the agitation with the water/alcohol mix the slurry separates into an oil phase and a water phase without any intermediate emulsion phase. This allows the oil phase to be decanted by taking advantage of the fact that the oil phase will separate and float above the water/fibre phase. Using less than 40% alcohol ensures that an emulsion of the oil in the aqueous phase is avoided making separation of the oil a simpler task. The presence of 10 to 40% alcohol in the aqueous phase is critical to partitioning the oil phase from the aqueous phase so that the oil phase separates from the water phase without forming an oil water emulsion interphase. The presence of the alcohol ensures partitioning and avoids emulsification. This contrasts with the prior art processes that use solvent extraction to dissolve the oil, because in this invention there is no solvent salvation of the oil and thus the step of recovering the oil from the solvent is avoided. After the first decanting another quantity of water and alcohol is added with agitation and a second decanting is carried out to extract additional oil.

During the grinding and agitation to partition the oil and during drying of the solids, the temperature is preferably maintained below 70® C to prevent degradation of the flour and/or oil.

The separated oil is filtered and cleaned to complete the refining.

The coarse ground fibres are reground to a particle size below 250 microns and are then dried to a moisture content below 5%. The resultant flour has an oil content below 5%.

This process is applicable to all oil seeds and in particular sesame seeds.

Quality sesame seed flour can bring a better price than the oil so that this process makes it possible to process sesame seeds in a safe, natural process that produces two high quality products. Oil seed flour with protein contents greater than wheat flour are attractive because the physical and functional characteristics improves the marketability of the flour.

In another aspect of this invention there is provided a method of extracting protein from oil seeds which comprises the steps of
a) dehulling the seeds in the presence of water alone and removing the hulls
b) coarse grinding the wet dehulled seeds from step a) in the presence of a water and alcohol mixture which contains 10 to 40% alcohol by weight of water to release oil from the seeds and form an oil phase separate to the water phase
c) decanting the oil from the ground seeds
d) optionally repeating steps b) and c)
e) adding warm water to the oil extracted ground seeds and decanting the water phase
f) optionally repeating step f)
g) adjusting the pH of the warm water phase to be within the range of 3 to 7
h) clarifying the water phase into water and protein paste
i) optionally washing the protein paste with warm water and repeating step h)
j) drying the protein rich paste to form a high protein flour
k) wherein the temperature during steps a) to j) is maintained below 70° C.

The water soluble proteins extracted in this way can be sold as a food ingredient or as a protein supplement.

Sesame peptides are physiologically active and some have been identified as useful in treating hypertension.

Also present in sesame seeds are anti-oxidant compounds, lignans. Some of these are oil soluble [about two thirds] and will be present in the extracted oils and the remainder which are water soluble will be associated with the extracted proteins. Sesame lignans are sought after as natural bioactive compounds for use as pharmaceuticals and nutriceuticals.

The oil extracted seeds may be fine ground prior to the protein extraction. Alternately the oil and protein extracted seeds can be fine ground to form a flour. The fibre extracted during the protein extraction can be used as a food ingredient or blended with other flour.

The dried protein extracted flour is usually of improved colour with the extraction of the protein and is quite marketable particularly for blending. The degree of protein extraction can be selected by the number of repetitions of the extraction steps h) and i) and this also adjusts the protein content of the resulting flour.

### DETAILED DESCRIPTION OF THE INVENTION

The processing of sesame seeds to produce oil and flour in accordance with the present invention will be described.

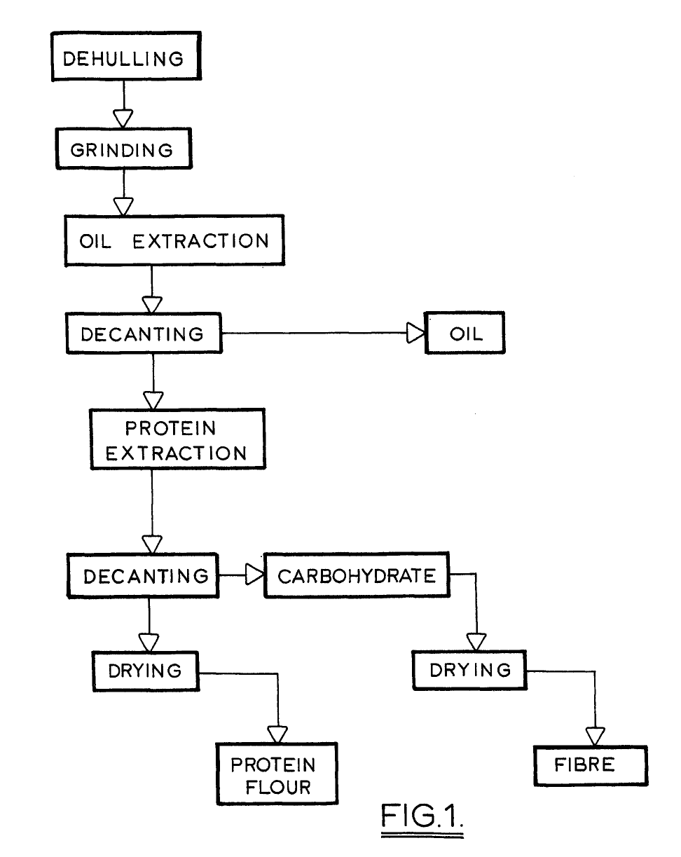

FIG. 1 is a schematic flow diagram of the main steps in the process. The steps as shown may be repeated to increase yields.

Dehulling

To 1 kg of sesame seeds is added 1 litre of water and allowed to soak for 4 minutes. The soaked seeds were then placed in a rotating sieve for about 5 minutes and agitated to remove the hulls from the seed.

Oil Extraction

250 ml of ethanol was added to the dehulled seeds and placed in a grinding mill. During grinding a 500 ml of water was added. The grinding raised the temperature of the mixture to 60° C. After grinding the slurry was placed in a malaxing tank and gently agitated for 30 minutes and allowed the oil to form as a separate phase floating on the aqueous phase, then passed through an inclined decanter which allowed the oil phase to be removed. 300 grams of oil were collected.

The deoiled slurry was returned to the malaxing tank for further agitation. If necessary additional alcohol may be added at this stage.

After another thirty minutes agitation the slurry was returned to the decanter for a second stage separation where 90 grams of oil were recovered.

The oil was filtered and clarified and was then ready for bottling.

If necessary the oil may be bleached to improve the colour.

The specification of the oil produced was:

| | | | |
|---|---|---|---|
| Color - lovibond | yellow50/red 3.9 | Peroxide value | 0.68 |
| | | [meq/kg] | |
| Flavour | slight nutty | Free fatty acid | 0.93 |
| | | % oleic | |
| Appearance | Clear | Phosphorous | 0.003 |
| Saponification value | 190-195 | Smokepoint | 190-200° C. |
| Relative density | 0.910-0.925 | Impurities | Max. 0.3% |
| | | Foots | Clear at 65° C. |

The main fatty acid components of the oil are:

| | |
|---|---|
| Palmitic | 9% |
| Stearic | 5% |
| Oleic | 45% |
| Linoleic | 41% |
| Lonoleic | 0% |
| Total saturated | 14% |
| Total monounsaturated | 45% |
| Total polyunsaturated | 41% |

Liquid Recovery

The residue from the oil recovery was separated into a liquid and solid phase. The liquid phase was placed in an evaporator to recover the alcohol for reuse in the oil extraction step. The water was also recycled for reuse. If there are water soluble allergans present in the extracted water phase these are preferably removed and evaporation of the water is one option.

Flour Preparation

To produce a high protein flour the solids are treated with water or alcohol/water (and may be treated more than once) to extract carbohydrates in the liquids separated from the solids to concentrate the protein in the solids.

The solids from the liquid separation were placed in a drier below 70° C. for a time sufficient to reduce the moisture content of the coarse flour to below 5%.

After drying the coarse flour was fine ground to below 250 microns. The resultant product was a fine white flour with an oil content below 5%.

To produce a high protein flour the solids are treated with water or water alcohol at a temperature below 60® C to extract soluble protein. The pH of the solution is generally adjusted to within the range of 3 to 7 to precipitate the protein. This extraction is usually performed twice. The protein paste is dried and used as a high protein flour or as a protein powder additive or formed into tablets for use as a protein supplement.

The flour specification is:

| Mesh size | <300 microns |
|---|---|
| Moisture | 4% |
| Protein | 65-75% |
| Oil | 5% |
| Ash | 7.3% |
| Soluble sugars | 7.5% |
| Fibre | 3.5% |
| Starch | 7.1% |
| Minerals | 6.5% |
| Impurity | 0.0% |

The mineral content is made up of calcium iron, selenium, manganese, zinc, copper, cobalt, phosphorous.

The functional properties of the flour are:

| | |
|---|---|
| Fat absorption (%) g oil/g flour | 185 |
| Water absorption (%) g water/g flour | 198 |
| Emulsification activity | 45.2 |
| Emulsification stability | 85.2 |

The amino acid analysis of the high protein flour in g/100 g protein is:

| | |
|---|---|
| Arginine | 12.9 |
| Histidine | 2.6 |
| Isoleucine | 3.6 |
| Leucine | 6.8 |
| Lysine | 1.3 |
| Methionine | 3.2 |
| Phenylalanine | 4.4 |
| Threonine | 3.6 |
| Triptophan | 1.9 |
| Valine | 4.3 |
| Cysteine | 1.2 |
| Aspartic | 7.8 |
| Glutamic acid | 14.2 |
| Serine | 4.0 |
| Glycine | 4.3 |
| Proline | 6.8 |

Peptides and Lignans

The protein solution can be treated with an enzyme, preferably a protease or an hydrolytic enzyme to produce a protein peptide mixture. This mix can be used as a food additive or supplement.

Additionally the peptide protein mix can be separated by any suitable technique to separate out the peptide fraction. Ultrafiltration through a suitable membrane is preferred.

Lignans can be separated from the oil phase or the protein by Ultra filtration.

From the above description it can be seen that this invention provides a cost effective method of producing flour and oil from sesame seeds.

1) A method of producing a flour and oil from oil seeds which includes the steps of
a) dehulling the seeds in the presence of water alone and removing the hulls
b) coarse grinding the wet dehulled seeds from step a) in the presence of a water and alcohol mixture which contains 10 to 40% alcohol by weight of water to release oil from the seeds and form an oil phase separate from the water phase
c) decanting the oil from the ground seeds
d) optionally repeating steps b) and c)
e) drying the ground seeds
f) finely grinding the ground seeds to form a flour at any time after step d)
g) wherein the temperature during steps a) to f) is maintained below 70° C.

2) A method as claimed in claim 1 in which sesame seeds are used.

3) A method as claimed in claim 2 in which the cleaned sesame seeds are saturated with 50-100% by weight of water prior to dehulling.

4) A method as claimed in claim 3 wherein alcohol in an amount of 30 % by weight of the dry seeds is added to the dehulled seeds prior to grinding.

5) A sesame flour produced by the method of claim 2.

6) Sesame oil produced by the method defined in claim 2.

7) A method of extracting a high protein flour and oil from oil seeds which comprises the steps of
a) dehulling the seeds in the presence of water alone and removing the hulls
b) coarse grinding the wet dehulled seeds from step a) in the presence of a water and alcohol mixture which contains 10 to 40% alcohol by weight of water to release oil from the seeds and form an oil phase separate from the water phase
c) decanting the oil from the ground seeds
d) optionally repeating steps b) and c)
e) adding warm water to the oil extracted ground seeds and decanting the water phase
f) optionally repeating step f)
g) adjusting the pH of the warm water phase to be within the range of 3 to 7
h) clarifying the water phase into water and protein paste
i) optionally washing the protein paste with warm water and repeating step h)
j) drying the protein rich paste to form a high protein flour
k) wherein the temperature during steps a) to j) is maintained below 70° C.

8) A method as claimed in claim 7 in which sesame seeds are used.

9) A method as claimed in claim 8 in which the pH in step h) is 3 to 5.

10) A method of producing sesame peptides which consists of treating the protein paste obtained in the process of claim 7 with an enzyme to produce a peptide mixture and optionally separating the peptide fraction from the protein.

11) A high protein sesame flour produced by the method of claim 8.

12) A sesame oil produced by the method defined in claim 8.
